(19) United States
(12) Patent Application Publication
(10) Pub. No.: US 2003/0207245 A1
(43) Pub. Date: Nov. 6, 2003

(54) Method and system for providing online distance learning

(76) Inventor: Alexander F. Parker, New York, NY (US)

Correspondence Address: Steven B Pokotilow, Stroock & Stroock & Lavan, 180 Maiden Lane, New York, NY, 10038, US

(21) Appl. No.: 10/276,967

(22) PCT Filed: May 23, 2001
(86) PCT No.: PCT/US01/16898

(51) Int. Cl. G09B 3/00

(52) U.S. Cl. 434/350

(57) ABSTRACT

A system and method for presenting a student user a modularized course via a network, such as the Internet. The course is segmented into modules. A course preferably includes the following categories of modules: preparatory, lecture, interactive and test. Alternate embodiments of the present invention provide users, professors and teachers with an interface by which they can search modules by topic or subject matter. The system of such embodiments identifies modules related to the topic or subject matter being searched. Having identified the modules, the users, professors and teachers can select some or all of the identified modules and rearrange such modules into a new course. The new course may be stored in the system and offered as a separate course to students. Accordingly, the system allows new, customized courses to be created from existing courses.

### CROSS-REFERENCE TO RELATED APPLICATIONS

This application claims the benefit of U.S. Provisional Application Serial No. 60/206,769, filed May 23, 2000, titled METHOD AND SYSTEM FOR CREATING, ORGANIZING, INTERACTING WITH AND VIEWING AUDIO-VISUAL WORKS, INCLUDING EDUCATIONAL MATERIALS.

### BACKGROUND OF INVENTION

1. Field of the Invention

The present invention relates generally to distance learning and, more particularly, to methods and systems for providing modularized lectures and courses via a network, such as the Internet.

2. Description of Related Art

The Internet has provided educators with a new medium for delivering educational materials to a diverse, geographically remote audience. For example, corporations have begun offering continuing education and training to employees via the Internet, and universities have been providing educational content to students via the Internet. In short, the Internet exists as a medium through which educators can communicate to a widely distributed audience.

As such, an industry is emerging to provide such distance learning. However, existing distance learning systems utilize the Internet as a learning tool simply as a communications medium, leaving the potential of the Internet largely untapped. For example, typical distance learning systems deliver classroom lectures via the Internet with little or no modification. As such, existing distance learning systems fail to efficiently exploit the interaction capability of the Internet. Simply streaming existing lectures via the Internet also requires prolonged concentration on a computer screen thereby promoting fatigue. Furthermore, each student participates in the class in isolation, without receiving the benefit of other students' experiences with the same course. Thus, existing online courses typically provide each student with an isolated, non-interactive experience.

Accordingly, a need exists for an improved method and system for providing distance learning and, more specifically, for a distance learning method and system that provides each student an interactive learning experience and leverages the collective experience of all students participating in a given class.

### SUMMARY OF THE INVENTION

The present invention satisfies the foregoing, as well as other, needs. In one embodiment, the invention provides a system and method for presenting a student user a modularized course via a network, such as the Internet. The course is segmented into modules. A course preferably includes the following categories of modules: preparatory, lecture, interactive and test. As noted herein, the combination of these categories of modules results in an effective course presentation, wherein users are immersed in an interactive, nonisolated learning environment.

In certain embodiments of the present invention, users, professors and teachers are provided an interface by which they can search modules by topic or subject matter. The system of such embodiments identifies modules related to the topic or subject matter being searched. Having the identified modules, the users, professors and teachers can select some or all of the identified modules and rearrange such modules into a new course. The new course may be stored in the system and offered as a separate course to students. Accordingly, the systems allows new, customized courses to be created from existing courses.

### BRIEF DESCRIPTION OF THE DRAWINGS

FIG. 1 is a schematic illustrating the system components according to one embodiment of the present invention;

FIG. 2 is a database schematic illustrating the relationship among the primary entities according to one embodiment of the present invention;

FIG. 3 is a database schematic illustrating the relationship among the primary entities related to user students according to one embodiment of the present invention;

FIG. 4 is a database schematic illustrating the relationship among the primary entities related to courses according to one embodiment of the present invention;

FIG. 5 is a database schematic illustrating the relationship among the primary entities related to staff according to one embodiment of the present invention;

FIG. 6 is a course map interface according to one embodiment of the present invention;

FIG. 7 is a preparatory module according to one embodiment of the present invention;

FIG. 8 is an interactive module according to one embodiment of the present invention;

FIG. 9 is a test module according to one embodiment of the present invention;

FIG. 10 is a test module according to one embodiment of the present invention; and

FIG. 11 is a course player interface according to one embodiment of the present invention.

### DETAILED DESCRIPTION OF THE PREFERRED EMBODIMENTS

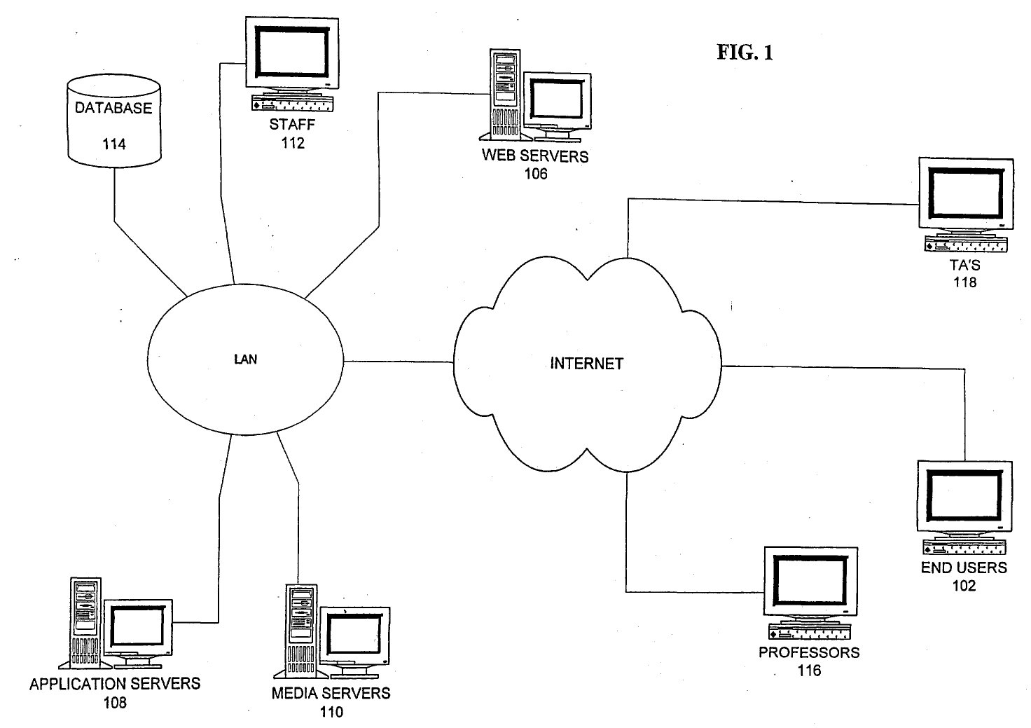

Certain embodiments of the present invention will now be described in greater detail with reference to the aforementioned figures. As shown in FIG. 1, one exemplary embodiment with present invention allows students or end users 102 to participate via processing devices, such as personal computers, in an on-line learning experience generated by a course provider's distance learning system 104. More specifically, the distance learning system 104 of the present embodiment includes one or more web servers 106, application servers 108 and media servers 110 interconnected via a network, such as a local area network (LAN), which in turn, is coupled to the Internet. In general, the web servers 106 generate web pages that are accessed by the end users 102 participating in the learning experience. Users may log into their accounts, register for courses, view their course history and participate in courses via the service providers web pages. The web servers 106 also generate administrative web pages that are accessed by staff of the service provider, professors and teachers.

The application servers 108 generally provide the back-end functionality described herein. For example, the software residing on the application servers 108 write to and access the databases 114 as necessary.

The media servers 110 host the media content delivered to the end users 102. Such media may be in essentially any form or format, including, for example, streaming media, graphics, audio, video, textual and the like.

The distance learning system 104 further include one or more work stations 112 that permit the service provider's staff to interact with and control the distance learning system 104. As described in greater detail below, the system 104 also includes one or more databases 114 for storing information relating to courses, students and staff.

It is to be understood that the foregoing description of the distance learning system 104 is merely exemplary as other arrangements of hardware may be utilized in providing the learning experience and functionality described below. For example, alternate embodiments of the present invention utilize a load balancer for distributing end user accesses to the system, while other embodiments use specialized servers for providing discussion group functionality and search functionality. Furthermore, in an alternate embodiment, the course content and application software described herein are delivered to users on an electronic storage medium, such as a CD-ROM, for experiencing on a processing device.

Also shown in FIG. 1 are professors 116 that interact with the service provider, via processing devices or other communication devices, to create courses. Also coupled to the Internet and consequently, the distance learning system 104 are teachers (“TA's”) 118. Each TA 118 is assigned to teach one or more courses and, therefore, interact with the system 104 to administer courses by selecting course material, grading users, monitoring student participation and the like.

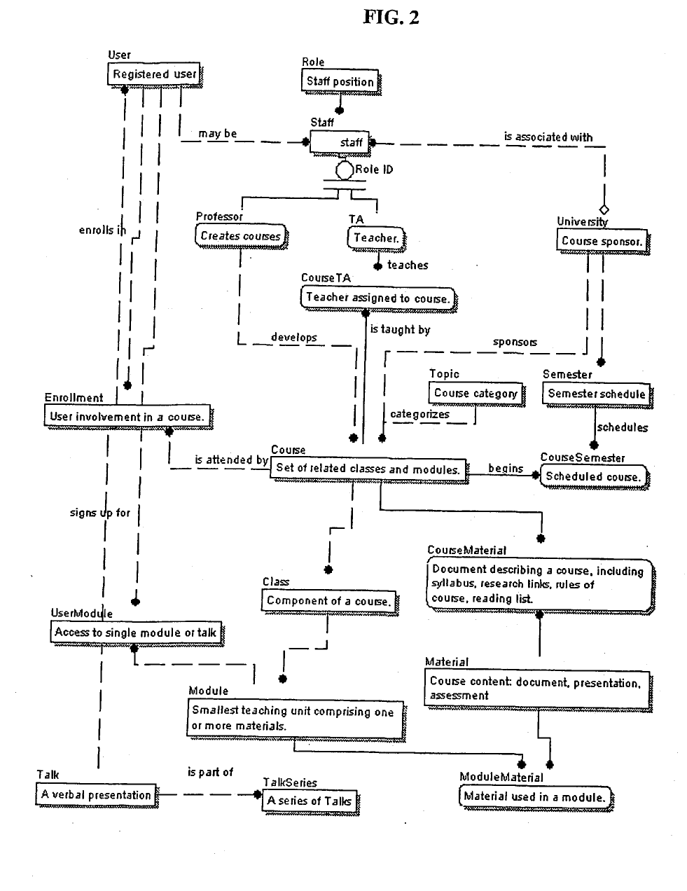

Having described the components of the distance learning system 104, the data model representing the databases 114 will now be described with reference to FIGS. 2-5. As will be understood by one skilled in the art, FIGS. 2-5 are presented as entity-attribute-relationship diagrams and therefore, provide a logical view of the data corresponding to the databases 114.

FIG. 2 illustrates the primary entities in the current embodiment and their relationships. As illustrated, each course comprises a set of related classes, and each class comprises a set of related modules. A module represents the smallest teaching unit. As described in greater detail below, modules according to the present embodiment fall into one of four categories: prepatory modules, which prepare the users for taking the class, lecture modules, which provide the educational content, interactive modules, which solicit input from each user, and test modules, which provide interactive testing for users. As also noted below, there are three types of test modules.

In general, each course is associated with documents describing the course (“coursematerial”), including the syllabus, research links, rules of the course, reading list and the like. Similarly, each module has material used in the module (“modulematerial”), and each course has associated content (“material”), including documents, presentation and assessment materials.

Each course is also associated with several other entities. More specifically, each course has associated therewith the enrollment for the course, the course TA assigned to teach the course, the professor that created the course and the university sponsoring the course. As illustrated, the user enrollment is a subset of all registered users. Furthermore, the service provider staff interacts with the universities, professors and TAs to efficiently create and deliver courses. Preferably, each staff member has a defined role, including, for example, TA and/or professor.

For use in administering the courses, the distance learning system 104 further includes each semester schedule (“semester”) and, for each course, an indication of when the course begins (“coursesemester”).

In an effort to provide the users with a broad range of learning experiences, the present embodiment allows users to register for individual modules (“usermodule”) and for presentations or talks (“talk”) that are part of a larger series of talks (“talkseries”).

Notably, each course is characterized by topic. By associating each course with one or more categories of topics by topic. By associating each course with one or more categories of topics, the system 104 is able to efficiently search courses based on user input.

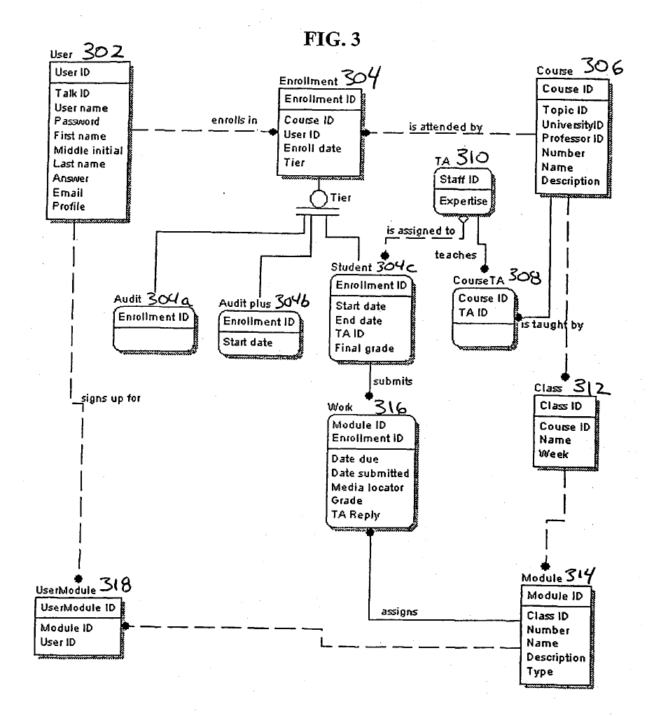

Having generally described the relationship among entities of the present embodiment, such relationships will now be described in greater detail with reference to FIGS. 3-5. FIG. 3 illustrates tables in the databases 114 relating to student users. The user table 302 includes a record for each user, identified by a user-identifier (ID). Each record includes various user identifying information, including the user's name, e-mail address and profile, such as the user's demographics, interests, options and the like. Also included in each record is the user's password for accessing the user's account and an answer to a lost-password question, such as “what is your mother's maiden name.” Such user-identifying information is typically obtained during an initial registration process with the service provider, for example, via an on-line form generated by the system 104 or a manual process whereby a staff member enters the information into the system 104 via the workstation 112. In the present embodiment, each record also includes a talk ID which identifies any talk for which the user has registered.

When a user enrolls in a course, a record is created in the enrollment table 304. In the present embodiment, like system 104 presents to the user web pages that provide a listing of courses. The user's selection(s) is received and used to update the enrollment table 304. The enrollment table includes a record for each such enrollment, identified by an enrollment ID. Each record further includes the user ID of the user enrolling in the particular course, which is also identified in the record by its unique course ID. Preferably, each record also includes the date on which the user enrolled in the course (“enroll date”).

The present embodiment provides for various levels or tiers of enrollment, as identified by the “tier” field in the enrollment table 304. In the present embodiment the user may select when enrolling one of the three tiers: audit, audit plus, and student. A user registered under audit status may only view the preparatory and lecture modules, but not participate in the interactive modules; a user registered under audit plus status may view the preparatory and lecture modules, as well as participate in interactive modules and user-to-user test modules (described below); and a user registered under student status may take the course for credit and a grade, participating in all modules and interacting with faculty and staff. Because enrollment as a student involves issuance of a grade, the student table 304c includes, for each enrollment ID, start and end date, a TA ID for the course and a final grade. In alternate embodiments the databases include additional fields of information associated with users, including a cumulative grade field (such as a numerical grade or grade point average), total credits field, and the like.

The databases 114 further include a course table 306, which includes a record for each course, as identified by a unique course ID As noted above, each record includes a topic ID university ID and professor ID, identifying the topic, sponsoring university and creating professor of the course, respectively. Each record further includes a course number and name, as well as a course description.

As also noted above, each course is associated with a course TA and one or more classes. Accordingly, the databases 114 include a course TA table 308 which identifies a TA and associated course by IDs. As illustrated, each course TA is taken from a universal table of TAs 310, which identifies the TA's staff ID and area of expertise.

The class table 312 identifies the classes comprising each course. To this end, each record in the class table 312 relates to a particular class as identified by class ID. Each class ID, in turn, is associated with the relevant course ID. Furthermore, each class is given a name and the week during which the class is given.

The module table 314 identifies the modules corresponding to each class. More specifically, each record in the module table 314 includes a module ID which uniquely identifies the module, as well as the class ID of the class to which it belongs. The record also includes the module name and module number. Each record also includes a description of the module, a list of keywords relating to the subject matter of the module, and an indication of the module type (e.g., document, presentation or assessment, worksheet, link, transcript, homework, evaluation, talk and the like). Each module that includes a lecture component also preferably includes a transcript of the lecture stored in the databases 114 and associated with the module. As noted below, the transcript not only is provided to users, but also is searchable.

Each module may have associated with it particular assignments or work. Such assignments are tracked in the worktable 316. Each assignment in the work table 316 has an associated record identified by module ID and enrollment ID, thereby associating the assignment with both a user and class. Each record further includes a due date for the assignment, the date submitted for the assignment, a media locator, for identifying the location of the user's submission, the user's grade and the TA's reply.

Lastly, each user may enroll for a particular module. Such enrollment is tracked in the usermodule table 318. Each record in the usermodule table 318 corresponds to an enrollment, uniquely identified by a usermodule ID. Each record identifies the module, by module ID, for which the user, as identified by the user ID registered.

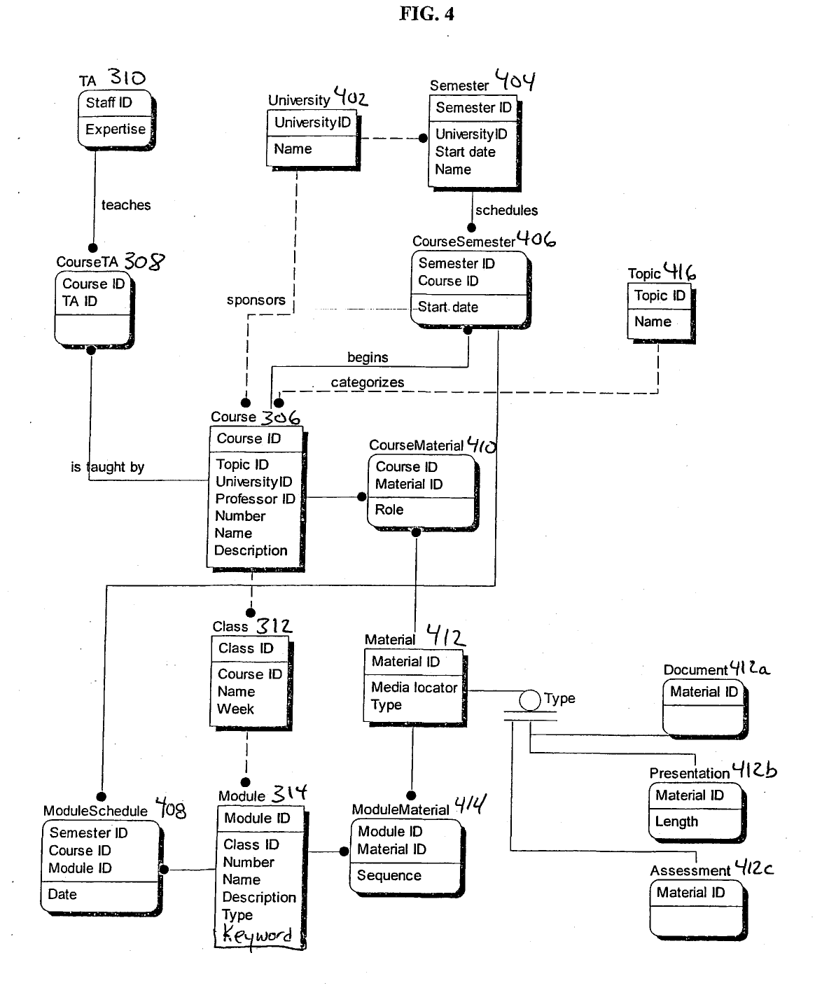

Tables illustrating the relationship of entities associated with courses will now be described in greater detail with reference to FIG. 4. As illustrated, many of the same tables described above with reference to FIG. 3 as relating to a user are described herein as relating to a course. In addition to those tables noted above, the databases 114 include tables relating to the university sponsors, course schedules and course materials.

More specifically, the databases 114 include the university table 402, which includes a record for each university, as identified by a unique university ID, sponsoring a course. In addition to the university ID, each record includes the name of the university. Because the course table 306 includes a field for the university ID, the databases 114 are able to associate the name of the university sponsoring each course.

Information concerning the university's semester is contained within the semester table 404. The semester table 404 includes a record for each university's semester, as identified by a semester ID. The record identifies the particular university ID, as well as the start date for the university's semester and the name of the semester. More specifically, the databases 114 include information on the courses for each university semester. Such information is stored in the coursesemester table 406. As illustrated, the course semester table 406 identifies the start date for each course of a semester.

Similarly, each module has a defined start date. Such information is contained within the moduleschedule table 408. More specifically, each module ID pertaining to a course ID, pertaining to a semester ID, the module schedule table 408 identifies the date for the module. As will be appreciated by those skilled in the art, information pertaining to the semesters and the start times of courses, classes and modules is useful in administering the courses, tracking enrollment, tracking student participation and the like.

Each course has associated therewith course materials, as identified in the course material table 410. For each course, as identified by the course ID, there exists materials, as identified by one or more material IDs. For each record pertaining to a course and material ID, the course material table 410 also specifies the role of such material, including for example, syllabus, rules of course, research links, reading lists, evaluations, best student work and the like.

A material table 412 contains records for each material ID. Each record in the material table 412 associates a material ID with a media locator and a type. More specifically, in the present embodiment, course material is classified as either being a document, presentation or assessment type material. The media locator identifies the location of the particular material within the distance learning system 104. For example, the media locator identifies the media server 10 and file name of the particular media file. By way of non-limiting example, the hypothetical media locator: “http://mms.mediaserver_{—}1/course_{—}1/class_{—}1/module_{—}1.asf” would point the file “module_{—}1.asf” located in the “course_{—}1/class_{—}1” directory of the media server 110 named “mediaserver_{—}1.”A listing of each item of a particular material type is contained in a separate document 412, presentation 412 and assessment 412 table. For each presentation, the presentation table 412 further identifies the length (preferably in units of time) of the presentation.

The material may also be associated with a specific module in the modulematerial table 414. As illustrated, course material, as identified by material ID, is associated with a module, as identified by a module ID. Furthermore, each record pertaining to course material for a given module includes an indication of the sequence of the material for use in the specified module.

As noted above, each record in the course table 306 includes a topic ID. Such topic ID corresponds to an entry in the topic table for 16. Each record in the topic table 416 includes the name of the topic for a given topic ID. Exemplary topics include history, geography, media, and the like.

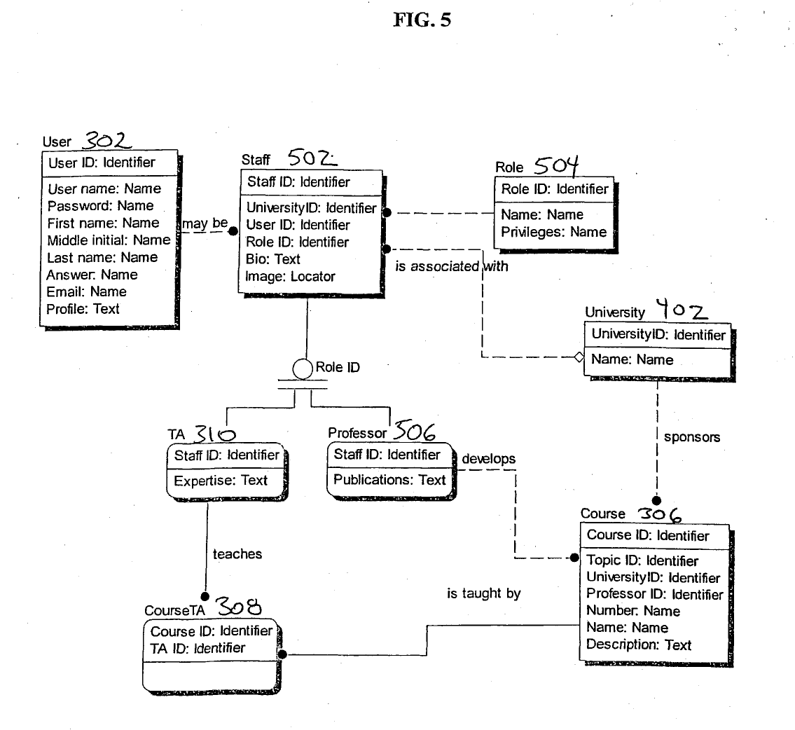

Tables logically illustrating entities related to the service provider staff will now be described with reference to FIG. 5. The databases 114 include a staff table 502 that includes a record for each member of the service provider staff as identified by staff ID. Each record in the staff table 502 includes, as applicable: a university ID, if the staff member is associated with the university; a user ID, if the staff member is also a user; a role ID, identifying the staff member's role; a biography; and an image. As illustrated, inclusion of a university ID and/or user ID associates the particular staff member with the details contained in the university table 402 and/or user table 302, respectively.

The role ID contained in the staff table 502 corresponds to a record in the role table 504. Associated with each role ID in the role table 504 is the name of the role, such as TA or professor, and the associated privileges associated with that role, such as the ability to assign or change a grade.

Where a staff member's role corresponds to a TA, the staff member has an associated entry in the TA table 310. Similarly, if the staff member's roll corresponds to that of a professor, the staff member has an associated record in the professor table 506, which identifies the staff member by staff ID and the staff member's relevant publications.

As noted above, courses are preferably divided into classes, which in turn, are preferably divided into modules, or individual discrete portions of an overall lecture. Preferably, each module is no more than approximately eight minutes in length. Thus, lectures are broken into portions that are easily understable, with breaks to permit the user to rest before concentrating on the next portion (i.e., module) of the lecture. Moreover, the present embodiment seeks to enhance the learning experience by providing the different media types as appropriate to each module.

Because the present embodiment presents modules via a processing device, such as a personal computer, the service provider preferably uses different media types and tools to embellish, reinforce and enrich the primary lecture elements. In this regard, the present embodiment preferably utilizes classes with any combination of four or more categories of modules: preparatory; lecture; interactive; and test. In certain preferred embodiments of the present invention, each class of a course includes at least one of each of the foregoing four categories of module. In alternate embodiment, however, only a subject of the four categories of modules is used, while in other alternate embodiments additional categories of modules are used.

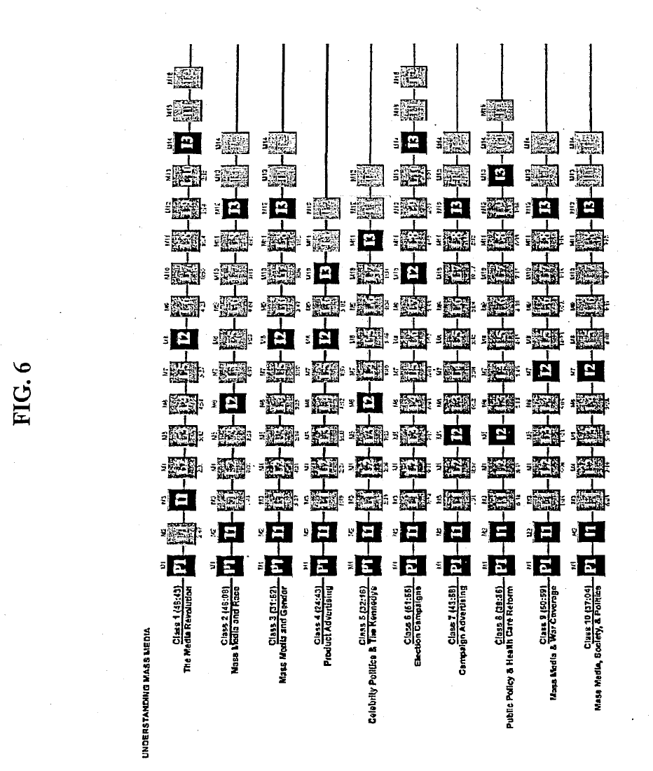

One exemplary logical course layout is shown in the course map of FIG. 6, in which each row represents a single class and each square in a row represents a module of that class. Each module, in turn, is identified as preparatory (P), lecture (L), interactive (I), or test (T). In other courses, the modules are arranged differently. For example, the preparatory module may be presented at the end of each class in preparation for the next class. Similarly, a class test module may be given during the following class. Also, there need not be a test modules for each class. In general, the preparatory module(s) precedes the lecture module(s) to which it relates; the test module(s) follow the lecture module(s) to which it relates; and interactive module(s) are interspersed therein. It should also be understood that a course may be logically divided into classes that themselves may comprise individual courses. For example, a course on art history consisting of 48 classes may contain a class directed solely to the Baroque period or a class directed solely to the use of mixed media, each of which may be offered as separate short courses. As described below, the course map exists as an interactive interface for professors, TAs and users to navigate the course modules and create new course offerings.

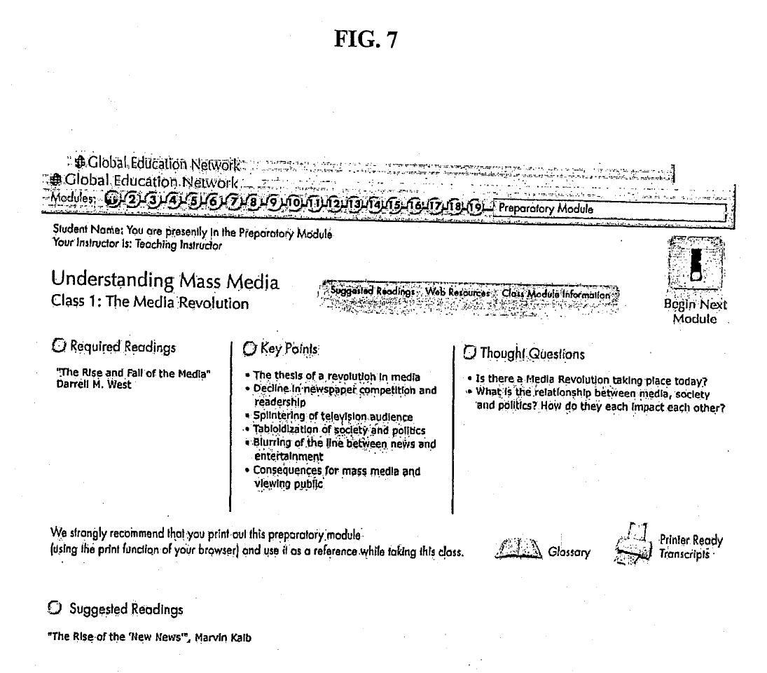

One exemplary preparatory module is illustrated in FIG. 7. Preparatory modules are generated by the system 104 as, for example, html pages. Prepatory modules (as well as the other modules) can also be dynamically generated by accessing information stored in the databases 114 and dynamically inserting such information within the module. A preparatory module includes preparatory information that the staff, professor and/or TA determines would be helpful in preparing a user for taking a course and/or class. More specifically, preparatory modules typically include (but are not required to include) a list of required readings, key points of the class or course, thought-provoking questions, suggested readings, links to related resources, a printable transcript of the course lecture, and the like.

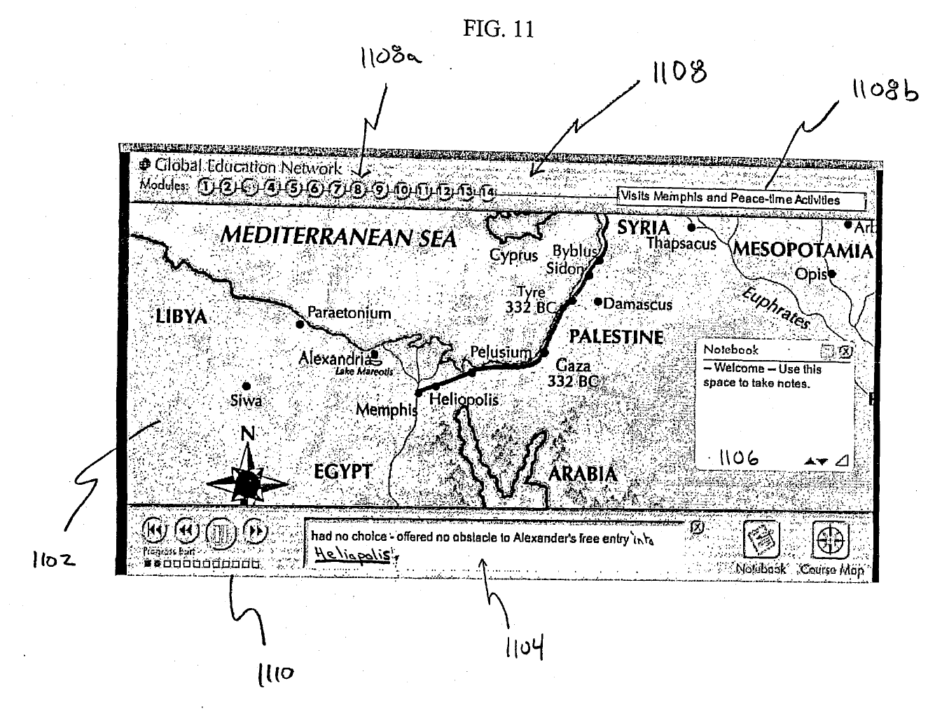

Lecture modules typically include any presentation by which the professor chooses to convey the subject matter of the course, including, for example, video of the professor, voiceovers, animations, illustrations, audio, graphics and the like. Such lecture modules will be discussed in greater detail below with reference to FIG. 11.

Generation of lecture modules typically involves a collaborative, iterative effort between the service provider and the professor. Preferably, the process is performed prior to recording the lecture, as merely filming an off-line lecture fails to provide a transcript that is readily segmented into modules. The process generally entails the professor and production staff collaborating to identify topical segments to form the primary subject matter being conveyed in each lecture module. It should be understood that multiple lectures may correspond to the same or related topical segments and that a single lecture may correspond to more than one topical segment.

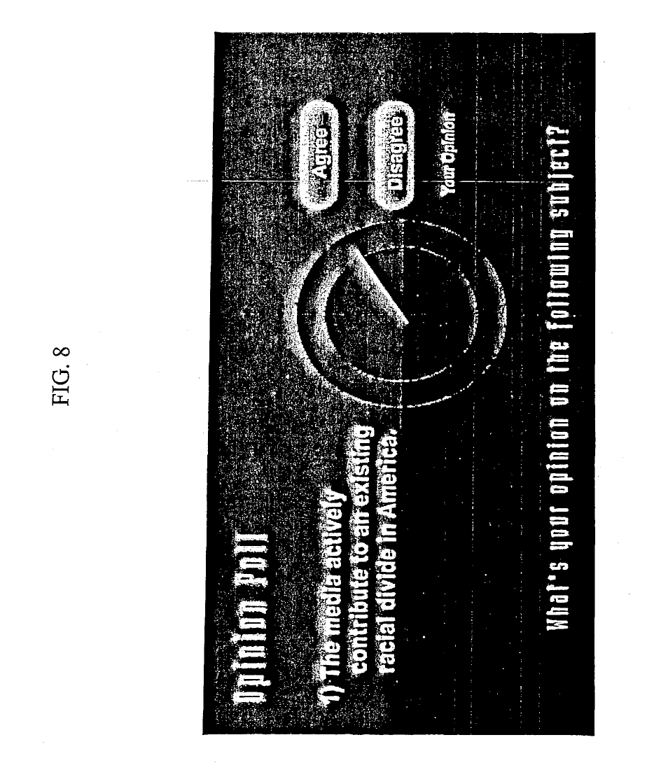

Interactive modules include one or more features that solicit a reaction or input from the user related to the subject matter of the course. For example, interactive modules may solicit the user's opinion, an answer, a suggestion or the like. Such user reaction is received by the system 104 and tabulated and stored in the databases 114 preferably an a user, semester course basis, enrollment and for later use in the class and to monitor the user's participation. An interactive module may come before and/or after the lecture module(s) to which it relates. By way of example, dispersed throughout a course may be interactive modules providing students with the same opinion poll. Having tabulated the results, the system 104 may provide feedback to the user's throughout the course as to how each users personal opinion may have changed, how the opinions of all students currently taking the course may have changed, and how past and present students' opinions have changed. As such, the present embodiment provides each user with an interactive, community-based learning experience rather than an isolated learning experience. In general, interactive modules are designed to elicit a better understanding of the course material and participation on behalf of users in furtherance of such an understanding. In certain instances, interactive modules represent queries a teacher may ask during an off-line lecture. An exemplary interactive module in the form of a user poll is illustrated in FIG. 8.

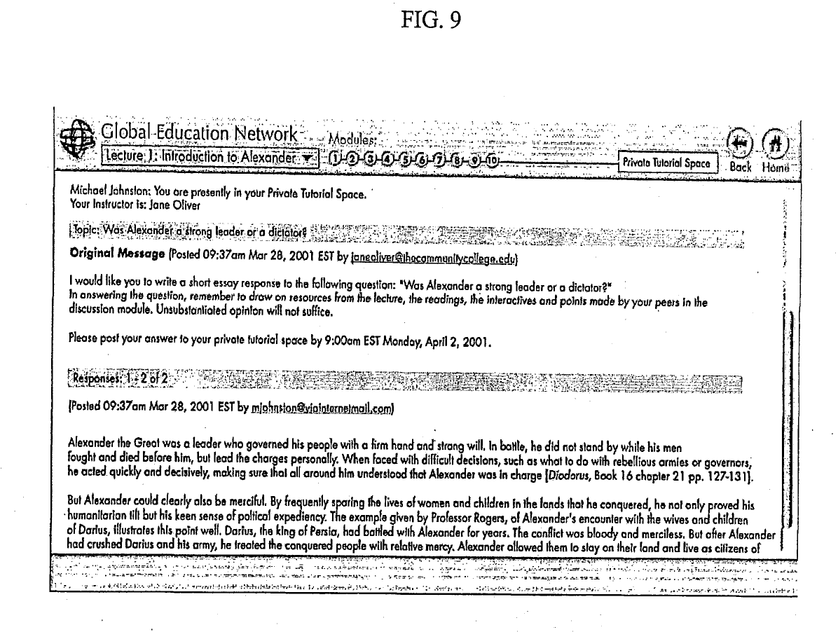

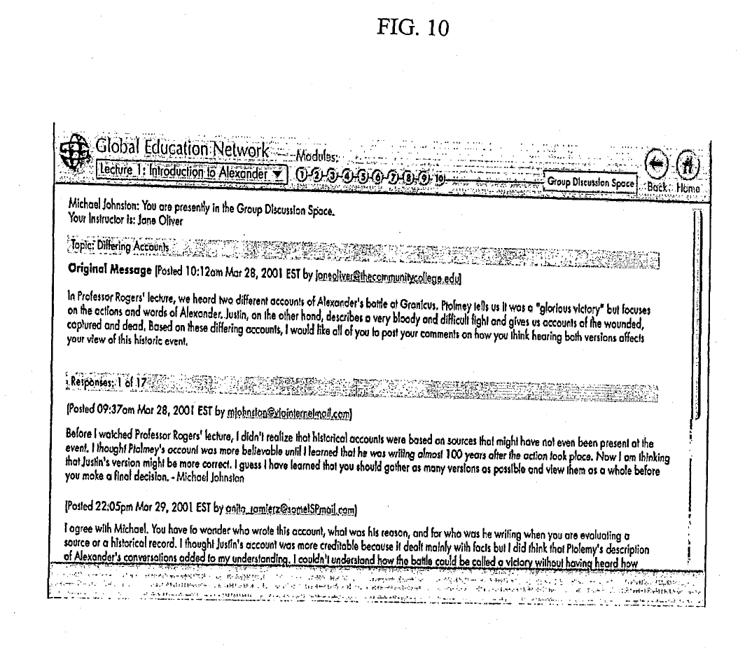

Test modules may take any of a number of forms (often dictated by the professor or TA) including, for example, a private communication between the user and TA, a discussion area shared by users participating in a class and overseen by the TA, or an area for factual test questions, such as multiple choice, true-false, drag and drop and the like, which are customizable by TA's. In general, test modules provide the TA the ability to qualitatively assess a user's performance in a course. An exemplary test module providing private user to TA interaction is shown in FIG. 9, and an exemplary test module allowing user-to-user interaction is illustrated in FIG. 10. Such test modules may be implemented using standard chat room or message board functionality as a component to an overall interface.

It is to be understood that the combination of the aforementioned categories of modules, P-L-I-T, contributes to an effective learning experience, in which users of the distance learning system 104 obtain a personalized, interactive learning experience. Furthermore, the use of discrete modules allows a professor to deal with discrete, but related, topics separately and also allows end users (students) to revisit an important topic of a class or course by simply viewing the relevant module of the class. The modularization of a class also permits the professor (or course producer) to include various types of modules, including preparatory modules, lecture modules, interactive modules, and testing modules, as described above. In short, the combination of the foregoing categories of modules allows for effective monitoring and evaluation of users participating in courses.

Having identified the system architecture, data model and modularization of courses of the present embodiment, operation of the embodiment will now be described with reference thereto. One skilled in the art will understand that the following description of features and functionality is provided for in software preferably residing on an application server 108. In alternate embodiments, however, such features and functionality are provided for by software residing on any one or more of the aforementioned components of the distance learning system 104 and/or client-side software residing on an end user's, TA's or professor's processing device.

It should be understood that while modules are preferably presented to the user via the same or similar interface, it is within the scope of the present invention for the modules to take different forms. For example, a preparatory module may be an e-mail or message board message presented to the user.

The course map of FIG. 6 will now be described in greater detail. As noted above, the course map includes a graphical indication of each module comprising each class in a course. In the present exemplary illustration, the class “Understanding Mass Media” comprises ten classes, with the first class, “The Media Revolution,” comprising sixteen modules totaling 47 minutes and 43 seconds of lecture material. It is to be understood that the course map is preferably presented to the users as a portion of an overall user interface through which the users, professors and TAs can search modules and rearrange modules into customized courses.

More specifically, the course map is preferably combined in an interface including a text box for accepting search terms from the user, professor or TA. A search engine software component residing on the application server 108 receives a search term or terms entered by the user, professor or TA and searches the keyword field in the module table 314, as well as the transcripts associated with each module. Once the search engine identifies the modules having keywords and/or transcripts including the search terms, the application server 108 causes the graphical depiction of those modules in the course map to be highlighted. The interface preferably also includes a textbox that, when the user, professor or TA highlights or selects a particular module in the course map, displays the description associated with that module.

As will be appreciated by those skilled in the art, the combination of these features allows users, professors and TAs to effectively search modules and the subject matter contained therein. In other words, users, professors and TAs are able to identify “threads” of information throughout a course.

In certain embodiments of the present invention, the course map may be utilized as a tool for creating customized courses. For example, a TA may search for a particular thread of information throughout a course. For example, in the existing course “Understanding Mass Media,” a TA may wish to focus on the correlation between the use of mass media and the economy. In such an instance the TA may search for the term “economy” and related terms, thereby identifying related modules. In response, the system would identify those modules having the term “economy” in either the module description or associated transcript. The TA may then select and reorder those modules into a customized course. Upon the TA indicating a desire to save the customized course, the system creates a new record in the course table 306 and assigns the customized course a course ID. The system also creates records in the related tables (as with other courses), such as the module table 314, which associates each of the selected modules (identified by module ID) with the newly assigned course ID. The ordering of the modules in the new course can be set forth either in the existing tables or in one or more additional tables associating the new course with the existing modules and their ordering in the new course. In one such embodiment, one additional table and one modified table are utilized to track the sequence of modules: a “Class_TA” table that correlates staff ID, Class ID and Sequence, thereby providing the sequencing of a particular staff member's classes; and a modified “Class_Module” table that correlates class ID, Module ID and sequence, thereby providing the sequencing of the modules in the class.

In alternate embodiments of the present invention, the course map provides a user with a graphical indication of that user's participation in the course, by, for example, highlighting those modules that the user successfully completed. Other indications of the user's progress through the course includes scores on the test modules, participation in interactive modules, completed assignments, outstanding assignments, and the like. Those of skill in the art will understand that such information may be conveyed either graphically on the course map, or via textual messages provided to the user via a separate text box.

An exemplary embodiment of a web-based course player for viewing and interacting with courses offered by a distance learning service provider will now be described with reference to FIG. 11. The course player (which is illustrated in the context of a lecture module) is preferably a web-based application accessible by a plurality of end users through a global communications network, such as the Internet. For convenience and ease of use, the course player may operate within a browser application, such as, for example, Microsoft Internet Explorer or Netscape Navigator. According to a preferred embodiment, the web-based course player is designed, developed and programmed using Macromedia's Director 8.5 Shockwave Studio and Flash (version 5). The Director 8.5 Shockwave Studio and Flash enables the course player to have various animated, interactive, graphical components, described in further detail below, which add to the learning experience. Of course, one skilled in the art will recognize that the course player can be developed within any software environment, such as Java or Visual Basic, and can run as either a server-side or client-side application.

The course player preferably comprises several interactive media components, including but not limited to a content window 110E, which may include a streaming video or audio component, a transcript window 1104, and a notebook window 1106. As described above, each course offered by the service provider is broken into several classes, which in turn are modularized into several modular components. For instance, a forty-five minute class may be broken into nine, five minute modules or segments.

Preferably, a class map (similar to the course map described above) control is graphically displayed on the course player and allows a user to view a map of modules related to the particular class, at any time during an interactive course experience. Furthermore, various module indicators 1108a link to the various modules of a particular class. Each module indicator is also linked to the module's name and/or description, as stored in the module table 314, which is graphically shown in a module name box 1108b. Using the module indicators, the user may select a module out of order or replay a particular module. The course player also preferably includes various player controls 110 which allow a user to play, pause, fast forward, rewind, or move between the various modules. The player controls may include a progress bar, as shown in FIG. 11, that graphically displays the progress of a particular module.

With reference again to FIG. 11, the various interactive components of the course player will now be described. As shown in the exemplary embodiment, the content window 1102 functions to display various images, html-based content, or other such displays relating to the content of the particular module being viewed. By way of example only, the present exemplary embodiment depicts a lecture module with an animated flash image showing a map of the route that Alexander the Great took to Heliopolis and Memphis. The content window 1102 also preferably includes a streaming media window, which functions to play various streaming video or audio components of a particular class module. The streaming video/audio component of the content window uses a media player plug-in, such as for example, RealPlayer, QuickTime or Windows Media Player, to operate. For instance, a recorded video of the professor's lecture may be shown in between interactive segments of the modules. In addition, streaming video or audio of a historical event may be played at any time during the class and shown in a content window. Of course, an additional window can be utilized to simultaneously play streaming content along with other content being displayed in the content window.

The course player also preferably includes a transcript window 1104 that displays various segments of text corresponding to the words spoken by the professor throughout the module. As noted above, the text is preferably stored in the databases 114 and associated with the module's module ID. During segments when the professor is not speaking, the transcript window 1104 could also be used to display relevant facts or other information related to the class module. According to the exemplary embodiment, various hyperlinks may be embedded in the transcript text. These hyperlinks link to content associated with the module or class and may include images, audio or video, definitions, or other related content. For example, as shown in FIG. 11, the term “Heliopolis” is hyperlinked to text explaining a key fact regarding the ancient city. Preferably, when clicked, the hyperlink text inputs the associated content into the course player and, in the case of text-based content, can drop the text block directly into the notebook window 1106, as described further below.

The course player also preferably includes a notebook window 1106, which functions to allow an end user to take notes throughout the class presentation. The notebook window is preferably a dragable and resizable window 1106 that operates similar to a word processing program. The notes typed into the notebook window by the end user may be saved for later retrieval by the end user. Moreover, as mentioned above, important key facts linked to various hyper-linked text can be directly imported into the notebook. Thus, as various definitions appear in the transcript window, an end user can click on the hyper-linked text and import a definition directly into the notebook window. In alternate embodiments, the notebook may be saved to the user's processing device or to the service provider's system.

With further reference now to FIGS. 1 and 4, the functional operation of the course player (shown in FIG. 11) will be described. When an end user 102 accesses a particular class through the Internet, the web server 106 make a call to databases 114 to retrieve all of the information necessary to deliver that class to the end user 102 through the course player. Once this information is retrieved (or substantially simultaneously therewith), the web server 106 sends a message to the application server 108 to launch the course player programming. The web server 106 pulls information such as the class ID from class table 312, the module IDs from module table 314, and the material ID and module sequence from material table 412 and module material table 414, respectively. Using the various IDs, the course player software operating on the application server 108 can pull the content necessary to deliver the chosen class from various databases 114 and from media server 110. For instance, if a particular video stream of a lecture is associated with a module ID, the application server 108 uses the material ID associated with that particular module ID, as stored in module material table 414, to pull the video stream associated from the media server 110. Furthermore, using the sequence stored in module material table 414, the course player software can load and play the course material in sequence. Yet further, the course player software operating on application server 108 uses “media locator” and “type” data, which are stored in material table 412, to determine the particular window through which the content is delivered. By way of example, content having a “type” set to “transcript” would have a corresponding “media locator” set to the “transcript window”. As such, the transcript text is properly sent to the transcript window of the course player.

Those skilled in the art will recognize that the method and system of the present invention has many applications, may be implemented in many manners and, as such, is not to be limited by the foregoing exemplary embodiments and examples. Moreover, the scope of the present invention covers conventionally known and future developed variations and modifications to the system components described herein, as would be understood by those skilled in the art. It will also be understood that various additional functionalities not described herein or later developed may be utilized in conjunction with the system and components described herein and are within the scope of the present invention.

1. A method for presenting educational material to a user, the educational material being arranged in a course comprising a series of classes, the method comprising:
for at least one class of the series of classes:
presenting one or more preparatory modules to the user, the preparatory module including preparatory information relating to at least a portion of the educational material;
presenting one or more lecture modules to the user, each of the lecture modules corresponding to a topical segment of the portion of the educational material covered in the class;
presenting one or more interactive modules to the user, the interactive module requesting input from the user; and
presenting one or more test modules to the user, the test module testing the user on subject matter relating to the portion of the educational material.

2. The method of claim 1, wherein the preparatory module precedes the lecture module corresponding to the portion of the educational materials.

3. The method of claim 1, wherein the preparatory module begins each of the classes and the interactive module is interspersed among the lecture modules.

4. The method of claim 1, wherein each class includes a test module.

5. The method of claim 1, wherein each class includes a preparatory module.

6. The method of claim 1, wherein each class includes an interactive module.

7. The method of claim 1, wherein multiple lecture modules correspond to the same topical segment.

8. The method of claim 1, further including offering the class as a separate course on the portion of the educational material.

9. A method for creating an online course for delivering educational material to a user, the method comprising:
segmenting a lecture into topical lecture modules;
creating a preparatory module including preparatory information for the lecture;
creating an interactive module requesting input from the user relating to the educational material; and
creating a test module testing the user on subject matter related to the educational material or initiating discussion on subject matter related to the educational material.

10. The method of claim 9, wherein the method further comprises:
determining a sequence of presenting the lecture modules to the user.

11. The method of claim 10, wherein the determining further comprises:
including the preparatory module in the sequence.

12. The method of claim 11, wherein the sequence has a beginning and the preparatory module is at the beginning of the sequence.

13. The method of claim 11, wherein the preparatory module is at an end of the sequence.

14. The method of claim 10, wherein the determining further comprises including the interactive module in the sequence.

15. The method of claim 9, wherein the creating of the interactive module further comprises creating at least two interactive modules requesting input from the user relating to the educational material.

16. The method of claim 10, wherein the determining further comprises: including the interactive modules in the sequence; and wherein the method further comprises:
interspersing the interactive modules throughout the lecture modules; and
providing feedback to the user based on the input to the interactive modules.

17. The method of claim 10, wherein the determining further comprises:
including the test module in the sequence.

18. The method of claim 10, wherein the sequence of the course comprises a plurality of classes and each of the classes includes a plurality of lecture modules.

19. The method of claim 18, wherein at least one of the classes includes the preparatory module.

20. The method of claim 18, wherein at least one of the classes includes the interactive module.

21. The method of claim 18, wherein at least one of the classes includes the test module.

22. The method of claim 13, wherein each of the classes further includes the preparatory module, the interactive module, and the test module.

23. A system for delivering educational material to a user via a network, the system comprising:
a server system having at least a processor and a data storage device, the server system being communicatively connected to a computer accessible by the user, and the processor of the server system operative with software to:
present a preparatory module to the user, the preparatory module including preparatory information relating to the educational material;
present one or more lecture modules to the user, each of the lecture modules corresponding to a topical segment of the educational material;
present an interactive module to the user, the interactive module requesting input from the user; and
present a test module to the user, the test module testing the user on subject matter relating to the educational material.

24. A method of creating a customized course from modules comprising one or more courses, the method comprising:
receiving an indication of a topic to search;
identifying one or more related modules based on the topic;
receiving a selection of one or more of the related modules, the selection identifying selected modules; and
associating the selected modules.

25. The method of claim 24 wherein the selected modules are offered as a new course.

26. The method of claim 24 wherein the selected modules are associated in a database.

27. The method of claim 24 wherein receiving an indication includes receiving a search term.

28. The method of claim 24 wherein identifying one or more related modules includes searching a group of keywords associated with the modules.

29. The method of claim 24 wherein identifying one or more related modules includes searching transcripts associated with the modules.
